(19) United States
(12) Patent Application Publication
(10) Pub. No.: US 2026/0230724 A1
(43) Pub. Date: Aug. 6, 2026

(54) Access Security System and Method for Capturing Video Images

(71) Applicant: Brivo Systems, LLC, Bethesda, MD (US)

(72) Inventor: Phillip Burr, Lehi, UT (US)

(73) Assignee: Brivo Systems, LLC, Bethesda, MD (US)

(21) Appl. No.: 19/042,851

(22) Filed: Jan. 31, 2025

(51) Int. Cl. H04N 25/531; G06T 7/90; G06V 10/145; G06V 40/16; H04N 23/611; H04N 23/74

(52) U.S. Cl. CPC H04N 25/531; G06T 7/90; G06V 10/145; G06V 40/161; H04N 23/611; H04N 23/74; G06V 2201/07

(57) ABSTRACT

An access device associated with an access point may be positioned at a fixed point inside or outside a building or area. When a person approaches the access point, embodiments may detect the person and try to capture an image of the person. If a face corresponding to the person is not completely visible within a window of the video camera field of view, embodiments may adjust the timing of a patterned light source and/or the shutter speed of a rolling shutter until the face is within a window of the video camera field of view.

### BACKGROUND

### Field of the Disclosure

This disclosure relates to access control solutions, and more particularly to systems and methods for capturing images by a video camera in various light conditions.

### Description of the Related Art

Video systems may capture images as part of a video stream. Continuously capturing a video stream may involve camera with a rolling shutter, wherein frames in a video stream are captured by continuously scanning a scene such that only parts of the image are recorded at the same time, but the image of the scene is displayed at once. Patterned light (also referred to as structured light) may be used to assist with user interfacing. For example, for liveness verification, patterned light may be projected at a face and the reflected light may be analyzed to determine if there is an actual face in front of a video camera or if an image of a face is within a field of view of the video camera.

### SUMMARY

Embodiments disclosed herein may be directed to a method for capturing an image of a face. The method may comprise detecting a person in a field of view of a video camera fixed at the access device, emitting patterned light into the field of view according to a patterned light timing, capturing, by a camera, a portion of an image of the field of view, determining the portion of the image does not contain a face, adjusting one or more of the rolling shutter timing and the patterned light timing such that the patterned light is emitted when the position of the window corresponds to the position of the face in the field of view, and capturing an image of the field of view when the patterned light is emitted and the face is in the window. The portion of the image may correspond to a window associated with a rolling shutter, the window may be smaller than the field of view and a position of the window relative to the field of view may correspond to a rolling shutter timing;

In some embodiments, adjusting one or more of the rolling shutter timing and the patterned light timing such that the patterned light is emitted when the position of the window corresponds to the position of the face in the field of view comprises increasing or decreasing the patterned light timing. In some embodiments, emitting the patterned light comprises a vertical-cavity surface-emitting-laser (VCSEL) emitting the patterned light. In some embodiments, the video camera comprises a complementary metal oxide semiconductor (CMOS) video camera. In some embodiments, adjusting one or more of the rolling shutter timing and the patterned light timing such that the patterned light is emitted when the position of the window corresponds to the position of the face in the field of view comprises increasing or decreasing a shutter speed of the rolling shutter. In some embodiments, detecting a person in a field of view of a video camera comprises analyzing a color channel.

Embodiments may be generally directed to a system for capturing an image of a person, the system comprising: a patterned light emitter; a processor executing a set of instructions to: determine a person is in a field of view of a video camera with a rolling shutter; determine the person is outside a visible area of the field of view; adjust one or more of a timing of the patterned light emitter or a shutter speed of the video camera to change the visible area; and capture an image of the person in the changed visible area. In some embodiments, the patterned light emitter comprises a vertical-cavity surface-emitting-laser (VCSEL). In some embodiments, the light emitter is configured to increase or decrease a timing of the VCSEL. In some embodiments, the video camera comprises an infra-red (IR) video camera. In some embodiments, the video camera comprises a complementary metal oxide semiconductor (CMOS) video camera. In some embodiments, detecting an object in a field of view of a video camera comprises analyzing a color channel.

Embodiments may be generally directed to an access device fixed at an access point, the access device comprising: a patterned light emitter; a video camera with a rolling shutter; and a processor executing a set of instructions to: detect a person is in a field of view of the video camera; determine the person is outside a visible area of the field of view; adjust one or more of a timing of the patterned light emitter or a shutter speed of the video camera to change the visible area; and capture an image of the person in the changed visible area. In some embodiments, the patterned light emitter comprises a vertical-cavity surface-emitting-laser (VCSEL). In some embodiments, the patterned light emitter is configured to increase or decrease a timing of the VCSEL. In some embodiments, the video camera comprises an infra-red (IR) video camera. In some embodiments, the video camera comprises a complementary metal oxide semiconductor (CMOS) video camera. In some embodiments, detecting an object in a field of view of a video camera comprises analyzing a color channel.

### BRIEF DESCRIPTION OF THE DRAWINGS

For a more complete understanding of the present disclosure and its features and/or advantages, reference is now made to the following description, taken in conjunction with the accompanying drawings, which are not drawn to scale, and in which:

FIG. 1 depicts a system architecture of a site having one embodiment of an access control system with access devices configured for capturing images at access points;

FIG. 2 depicts a system architecture of an access device configured for capturing images at an access point under various light conditions;

FIG. 3 depicts an exemplary image from a video stream received from a video camera, illustrating patterned light emitted onto a face within a window associated with a rolling shutter;

FIG. 4 depicts an exemplary image from a video stream received from a video camera, illustrating a face within a window when no patterned light is emitted;

FIG. 5 depicts an exemplary image from a video stream received from a video camera, illustrating patterned light emitted onto a face outside a window;

FIG. 6 depicts an exemplary image from a video stream received from a video camera, illustrating patterned light emitted partially onto a face outside a window;

FIG. 7 is a flow diagram, illustrating a method for capturing an image of a person by a camera with a rolling shutter;

FIG. 8 depicts a screenshot of a person in a field of view with a bounding box and face identification points for determining the presence of a face, in accordance with some embodiments; and

FIG. 9 depicts a screenshot of a person in a field of view, illustrating using one embodiment of a method for ensuring a face is within a window when patterned light is emitted.

### DETAILED DESCRIPTION

In the following description, details are set forth by way of example to facilitate discussion of the disclosed subject matter. It should be apparent to a person of ordinary skill in the field, however, that the disclosed embodiments are exemplary and not exhaustive of all possible embodiments.

As used herein, a reference numeral refers to a class or type of entity, and any letter or hyphenated numeral following such reference numeral refers to a specific instance of a particular entity of that class or type. Thus, for example, a hypothetical entity referenced by ‘12A’ or ‘12-1’ may refer to a particular instance of a particular class/type, and the reference ‘12’ may refer to a collection of instances belonging to that particular class/type or any one instance of that class/type in general.

Access systems may be useful for monitoring and/or controlling access to a door, a room, or an area in a site. Access systems may be particularly useful in environments such as enterprise, commercial, healthcare and wellness, manufacturing, education, financial services, religious institutions, AEC security, multifamily, vacation rental, hybrid workplace and emergency lockdown.

As an example, enterprise access controls may protect employees, visitors, and customers. All assets may be managed through one place, wherein security may be monitored through a single interface even across multiple sites. Physical access control may be connected with corporate identity and access management (IAM) to automate onboarding and offboarding. A business entity may be protected with access controls that can meet industry laws and regulations. For enterprises with more people and more sites, embodiments may provide analytics to understand usage patterns, threats, and abnormal behaviors. Access controls may include cybersecurity to reduce losses due to data thefts and breaches.

As another example, commercial, cloud-based security for modern offices may include frictionless flow from a garage to main doors to suite access. Parts of a visitor experience may be automated to create a welcoming, secure, and convenient first impression. Tracking occupancy levels may protect the health and safety of residents, such as by enforcing capacity limits. Data may be collected and analyzed to protect and manage visitors, users, employees, etc.

As another example, sensitive patient data, expensive medical equipment, prescription drug regulations, privacy and employee safety all necessitate robust access control throughout the healthcare industry. An access control trail and track member access to ensure active, legitimate members have convenient access to facilities, may track trends and detect anomalous behaviors, protect sensitive areas and patient data while creating an audit trail, and allow viewing of various access events from a single display.

In all these environments, access devices provide secure access control with convenience and ease of use. An access device may form part of a cloud-based access control system capable of controlling access to a plurality of different access points at any of multiple sites. Access devices are commonly fixed, such as to a wall, a frame or a ceiling, wherein a person wanting access through an access point approaches the access device to provide information to the access device to validate the person. The information may be entered manually or automatically. Examples of manually entered information may include personal identification numbers (PINs), passwords and biometric information such as fingerprints. Automatically entered information may include a fob or facial recognition, discussed in greater detail below.

### System Overview

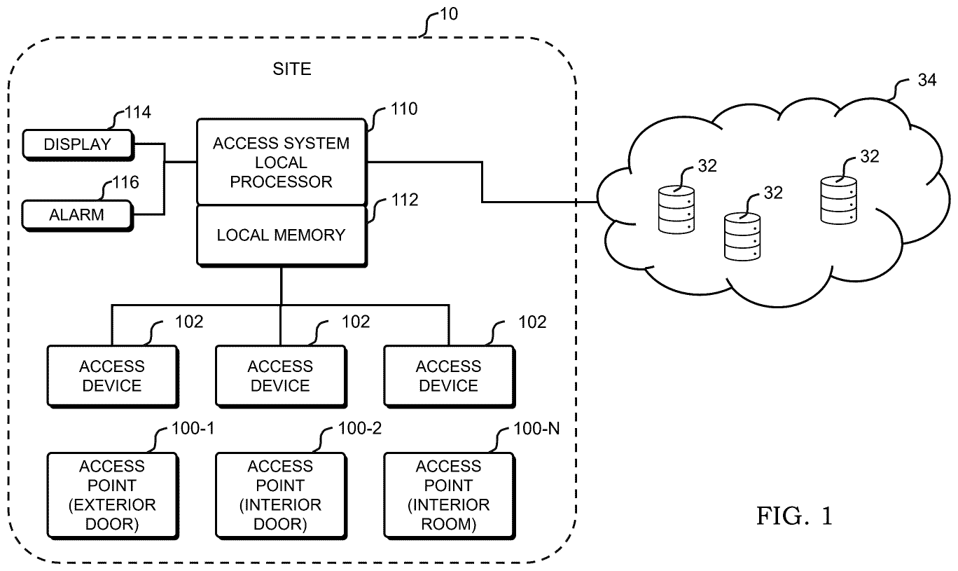

Turning to FIG. 1, a system architecture of embodiments disclosed herein may include (at site 10) access system local processor 110 communicatively coupled to one or more access devices 102 and to one or more servers 32 (in cloud 34). At site 10, access system local processor 110 may be communicatively coupled to a plurality of access devices 102, wherein each access device 102 may be associated with an access point (e.g., first access device 102 may be associated with an exterior door 100-1, second access device 102 may be associated with an interior door 100-2 and Nth access device 102 may be associated with an interior room 100-N). Access system local processor 110 may also be communicatively coupled to local memory 112, display 114 and alarm 116. Local memory 112 may store information associated with each person who should have access to which areas, each vehicle which should be allowed in which areas, etc. Local memory 112 may also store information associated with each access device 102, such as logs of access device interactions with people, how many people passed through an access point 100 associated with an access device 102, how many people were denied access by an access device 102, and/or what time people passed through (or tried to pass through) an access point 100 associated with an access device 102. Access system local processor 110 may communicate with display 114 to allow a user (e.g., security personnel, compliance personnel, maintenance personnel) to view information collected from access devices 102. Access system local processor 110 may signal alarm 116 if a person or vehicle improperly passes through an access point 100.

### Cloud Information Processing

Embodiments of cloud 34 may comprise a plurality of servers 32, wherein servers 32 may store information received from access devices 102 and local system processors 110. In some embodiments, servers 32 in cloud 34 may store information for a large plurality of persons, vehicles, etc. and communicate information to individual access devices 102 such that access devices 102 at different sites 10 are configured to determine whether a person, vehicle, etc. is authorized to access (e.g., enter an access point 100) an area associated with a specific access device 102.

### Access Devices

Access devices 102 associated with site 100 may be positioned inside or outside a building, including garages and other structures. Access devices 102 may be positioned and oriented to capture information, wherein access devices 102 may be fixed such that they do not translate or rotate.

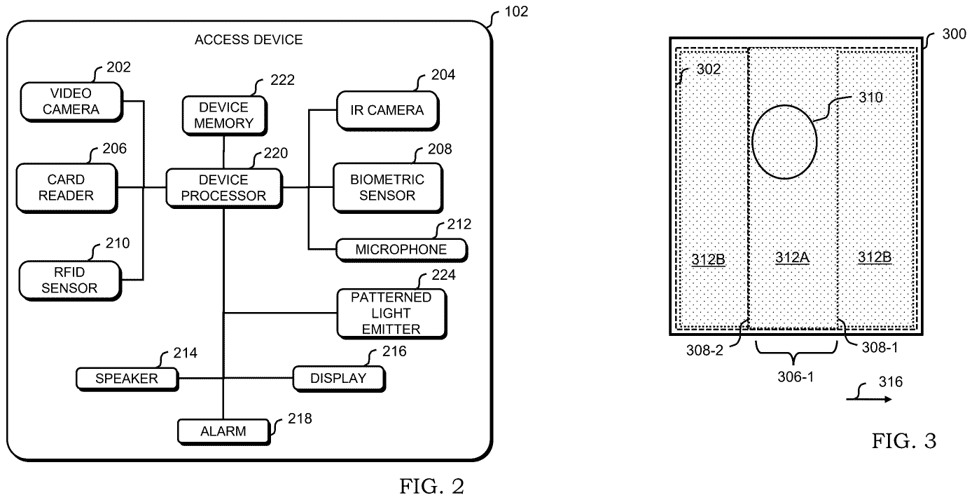

Referring to FIG. 2, each access device 102 may comprise a set of sensors and communication devices for interacting with a person. For example, access device 102 may comprise video camera 202, infra-red (IR) video camera 204, card reader 206, biometric sensor 208, RFID (Radio Frequency Identification) sensor 210, microphone 212, speaker 214, display 216, alarm 218 and patterned light emitter 224. Video camera 202 may capture an image or a video stream comprising a plurality of images associated with an access point 100 based on a field of view of video camera 202. IR video camera 204 may capture an image or a video stream comprising a plurality of images associated with an access point 100 based on a field of view of IR video camera 204. Card reader 206 may capture information from an access card. Biometric sensor 208 may capture biometric information (e.g., handprint, fingerprint, thumbprint, etc.) of a person. RFID sensor 210 may capture information from a device or card near access point 100. Microphone 212 may convert sound or pressure signals into electronic signals. Speaker 214 may convert electronic signals into sound or pressure signals. Display 216 may convert electronic signals into visual representations. Patterned light emitter 224 may emit patterned light to determine liveness, discussed below in greater detail.

Access device 102 may further comprise device processor 220 executing a set of instructions stored in device memory 222 to receive information from (or about) a person and determine whether the person is authorized to access (e.g., enter) an area. Device processor 220 may communicate with video camera 202 to capture an image or a video stream including a plurality of images associated with an access point 100. Device processor 220 may analyze the image or video stream to identify a person within a field of view (e.g., in front) of access device 102. Device processor 220 may communicate with IR video camera 204 to capture an IR image or a video stream of IR images and analyze the IR image or video stream to identify a person within a field of view of access device 102. Device processor 220 may communicate with card reader 206 to capture information from an access card as part of a method to determine whether a person is authorized to access (e.g., enter) an area associated with access point 100. Device processor 220 may communicate with biometric sensor 208 to capture biometric information about a person as part of a method to determine whether the person is authorized to access (e.g., enter) an area associated with access point 100. Device processor 220 may communicate with microphone 212 to capture audio information from a person as part of a method to determine whether the person is authorized to access (e.g., enter) an area associated with access point 100. Device processor 220 may further analyze audio information to determine what the person is saying in the vicinity of access point 100. Device processor 220 may communicate with a user (using speaker 214 and/or display 216) as part of a method to determine whether a person is authorized to access (e.g., enter) an area associated with access point 100.

### Capturing a Face for Authenticating a Person Access

As part of a process for identifying and authenticating a person, embodiments may capture an image (or images) in a video stream), determine the image contains a person, identify a face and compare the face in the image with information stored in memory to determine whether the face corresponds to an authorized person. Furthermore, embodiments may analyze an image to determine liveness. To facilitate authentication of individuals, embodiments disclosed herein may provide adaptive patterned light emission to accommodate variations in window size and/or rolling shutter speed.

Analyzing a Face Using a Camera with a Rolling Shutter and Patterned Light-Overview

FIG. 3 depicts an exemplary field of view 300 associated with camera 202, with window 304 having a width 306 between first scanline (e.g., reset scanline) 308-1 and second scanline (e.g., read scanline) 308-2. Ideally, a person's face 310 is within window 304 for capturing an image of face 310. Embodiments may emit patterned light 312 to determine liveness associated with face 310.

### Using a Rolling Shutter to Capture an Image

Scanlines 308 may be associated with a rolling shutter, wherein video camera 202 is constantly and rapidly capturing a portion (e.g., window 304) of field of view 300 but constantly presenting all portions as a single image 302. In an electronic rolling shutter, each pixel in each scanline 308 of video camera 202 can collect light. The electronic rolling shutter tracks two scanlines 308. One scanline (e.g., Read Scanline 308-2) is the scanline 308 that is actively reading sensor information data and another scanline (e.g., Reset Scanline 308-1) in advance of Read Scanline 308-2 that is resetting the scanline. Reset Scanline 308-1 will be some number of scanlines 308 ahead of Read Scanline 308-2 and the distance between Reset Scanline 308-1 and Read Scanline 308-2 becomes the effective shutter speed. After Read Scanline 308-2 has finished being read, both scanlines 308 are advanced and the next Read Scanline 308-2 will begin being read.

### Patterned Light Helps Determine Liveness

To prevent people from positioning pictures of face 310 in front of camera 202 to gain unauthorized access, embodiments may determine liveness. One way to determine liveness is to use patterned light, wherein embodiments may emit patterned light 312 into field of view 300 and analyze the reflected patterned light 312 to determine whether image 302 contains an actual face 310 of a person (e.g., patterned light 312 reflected off a person's face 310 in front of video camera 202 would be distorted relative to the original pattern) or whether image 302 contains a picture of a person (e.g., patterned light reflected off a flat picture of a person in front of video camera 202 would more closely match the original pattern). In some embodiments, access device 102 may comprise a VCSEL (Vertical-Cavity Surface-Emitting-Laser) as a patterned light emitter 224 for projecting patterned light 312, wherein device processor 220 may execute a set of instructions to determine if a pattern of the reflected light generally matches the original pattern or if the pattern of reflected light is more distorted relative to the original pattern.

### Patterned Light is not Emitted Continuously

Patterned light emitter 224 may be on only for a limited time to prevent overheating. For example, patterned light emitter 224 (such as a Vertical-Cavity Surface-Emitting Laser (VCSEL) or an in-plane laser) can flash patterned light 312 for a rated maximum ON period (e.g., VCSEL_ON), after which it must be turned OFF for a minimum time period (e.g., VCSEL_OFF).

A Camera with a Rolling Shutter Continuously Updates Portions of an Image

In some embodiments, video camera 202 may be a CMOS (complementary metal oxide semiconductor) type video camera 202 configured with a “rolling motion” to continuously capture and refresh image 302 in a video stream. Video camera 202 may be oriented such that window 304 refreshes image 302, with window 304-1 having size 306-1 moving from left-to-right (as illustrated with arrow 316) in FIG. 3, but video camera 202 may also be oriented or configured such that window 304-1 refreshes image 302 from top-to-bottom, bottom-to-top, or right-to-left, depending on the orientation of camera 202.

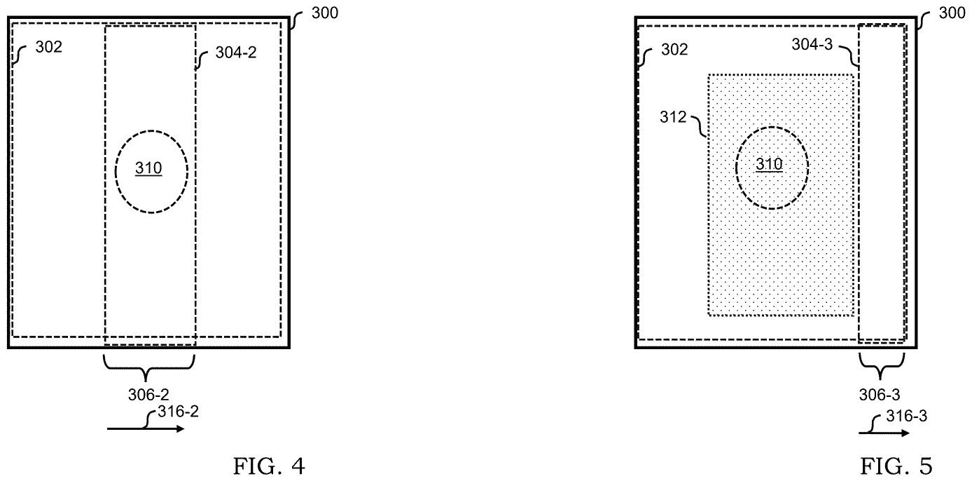

Referring to one or more of FIGS. 3-5, when the shutter speed increases and the distance between Reset Scanline 308-1 and Read Scanline 308-2 narrows, only a limited area of the sensor will be exposed to light while patterned light emitter 224 is ON (e.g., emitting light). This results in the final image only showing a portion of the patterned light 312 in a limited area (e.g., patterned light 312A). Referring to FIG. 3, when patterned light 312 is emitted when window 304-1 overlaps face 310, patterned light 312 may be analyzed by device processor 220 to determine liveness of face 310. Referring to FIGS. 4 and/or 5, when patterned light 312 is emitted anytime outside of when window 304 overlaps face 310, device processor 220 may be unable to determine liveness of face 310.

### Capturing Images of People's Faces

Access devices 110 may be rigidly fixed at access point 100, wherein capturing an image of a person's face 310 may depend on the position of the person's face 310 within a field of view 300 of camera 202 and the illumination in the vicinity of camera 202. Environmental conditions may change such that capturing quality images may be difficult.

Patterned Light Might not be Emitted Whan a Face is within a Window Corresponding to a Rolling Shutter

Referring to FIG. 4, if window 304-2 having size 306-2 is capturing image 302 when no patterned light 312 is emitted, image 302 might contain face 310 (illustrated by face 310 depicted with dashed lines), but determining liveness might not be possible.

A Person's Face Might be Off-Center and Therefore Outside a Window when Patterned Light is Emitted

FIG. 5 depicts a type of instance in which camera 202 might capture image 302 when face 310 is substantially centered in field of view 300 but window 304-3 does not contain face 310. Camera 202 may have a very fast shutter speed 316-3 and/or a small window size 306-3. When a person positions their face 310 substantially centered in field of view 300, if structured light pattern 312 is emitted after window 304 has passed an area of field of view 300 in which the person's face 310 is present, image 302 might not contain the person's face 310 to adequately determine liveness.

To overcome these deficiencies and others, embodiments may correlate a face position within field of view 300 and coordinate the emission of the structured light pattern 312 so that the structured light pattern 312 is emitted while window 304 overlaps or otherwise contains face 310 of the person for which the system is trying to determine liveness.

One approach for capturing images (including video streams) of faces 310 at access points 100 involves a patterned light source and a camera with a rolling shutter and further includes adjusting one or more of the timing at which the patterned light is emitted and the shutter speed of the video camera.

Embodiments disclosed herein may determine that a person is near an access device 102, determine the person's face 310 is within a field of view 300 of a video camera 202 associated with the access device 102, emit patterned light into the field of view 300 and capture an image or video stream of the person's face 310 using video camera 202. If face 310 is outside window 304, embodiments may adjust one or more of the shutter speed of video camera 202 or the emission timing of patterned light emitter 224 until face 310 is within window 304 when patterned light 312 is emitted.

Embodiments may calculate the timing for patterned light emitter 224 for a given shutter speed. As an example:

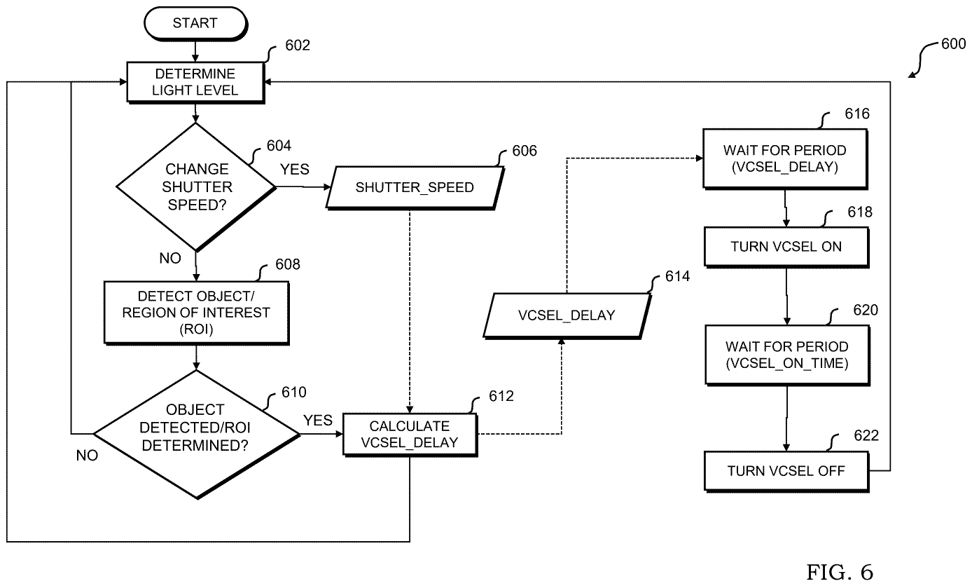

FIG. 6 depicts a flow diagram of method 600 for capturing face 310 in an image of a person by a video camera 202 at a fixed access device 102.

At step 602, embodiments may determine a light level. Determining a light level may comprise determining a value associated with a light level, such as reading an ambient light level from a sensor or may comprise determining a relative value associated with a light level (e.g., determining a light level based on commercial lighting or illumination standards).

At step 604, embodiments may determine whether to change the shutter speed based on the light level.

If, at step 604, embodiments determine the shutter speed needs to be changed based on the light level, then embodiments determine a parameter (e.g., SHUTTER_SPEED) 606 corresponding to the (new) shutter speed of video camera 202.

If, at step 604, embodiments determine the shutter speed does not need to be changed based on the light level, then at step 608, then embodiments detect an object (e.g., face 310) or region of interest (ROI). Detecting an object may comprise determining a person is present based on audio signals or detection of movement in the vicinity of camera 202. Detecting a ROI may comprise determining a direction of sound or motion associated with an object.

At step 610, embodiments determine whether an object is detected within field of view 300 or whether an ROI of field of view 300 is determined. For example, embodiments may detect an object in field of view 300 but determine, based on one or more of audio and motion, that the object is an animal or embodiments may determine there is an ROI in field of view 300 and determine, based on one or more of audio and motion, that the ROI contains a person.

If, at step 610, embodiments determine an object (e.g., face 310) is not detected and/or a region of interest (ROI) is not determined, then embodiments may repeat steps 602-608 until an object is detected or an ROI is determined.

If, at step 610, embodiments determine an object (e.g., face 310) is detected or an ROI is determined, then at step 612, embodiments may use parameter 606 (e.g., SHUTTER_SPEED) to calculate a second parameter (e.g., CVSEL_DELAY) 614 corresponding to how much time patterned light emitter 224 should delay emitting patterned light 312.

At step 616, embodiments wait for a period corresponding to parameter 614.

At step 618, embodiments turn on patterned light emitter 224 such that patterned light emitter 224 emits light in field of view 300 when window 304 includes face 310.

At step 620, embodiments wait for a period corresponding to VCSEL_ON_TIME.

At step 622, embodiments turn off patterned light emitter 224.

TABLE 1

| Variable | Definition |
|---|---|
| FPS | Frames per second [no units] |
| S | Number of scanlines [no units] |
| SHUTTER_Scanlines | Shutter in units of scanlines [no units] |
| V | VCSEL_ON_TIME [milliseconds] |
| ROI_Y0 | First scanline of ROI [no units] |
| ROI_Y1 | Last scanline of ROI [no units] |
| P | Frame period = 1/FPS [milliseconds] |
| ST | Scanline time = P/S [milliseconds] |
| ROI_Y | Center scanline of ROI [no units] |
| | (ROI_Y = (ROI_Y0 + ROI_Y1)/2) |
| VCSEL_ON_Scanlines | =Period the VCSEL is on [no units] |
| | (VCSEL_ON_SCANLINES = V/ST) |
| VCSEL_Visible_ | =VCSEL_ON_Scanlines + SHUTTER_ |
| Scanlines | Scanlines-1 [no units] |
| VCSEL_Start_Scanline | =MIN(MAX(0, ROI_Y − VCSEL_Visible_ |
| | Scanlines/2), |
| | S − VCSEL_ON_Scanlines) [no units] |
| VCSEL_Delay | =VCSEL_Start_Scanline * ST [milliseconds] |

For ease of understanding, Table 2 includes exemplary values for the variables disclosed in Table 1.

TABLE 2

| Variable | Value |
|---|---|
| FPS | 30 |
| S | 1080 |
| SHUTTER_Scanlines | 400 |
| V | 10 milliseconds |
| ROI_Y0 | 600 |
| ROI_Y1 | 800 |
| P | 33.3 milliseconds |
| ST | 33.3 milliseconds/1080 = |
| | 30.86 microseconds |
| ROI_Y | 700 = (600 + 800)/2 |
| VCSEL_ON_Scanlines | =10 milliseconds/.03086 |
| | milliseconds = 324 scanlines |
| VCSEL_Visible_Scanlines | =324 + 400 − 1 = 723 |
| VCSEL_Start_Scanline | =MIN(MAX(0, 700 − 723/2), |
| | 1080 − 324) = 338 |
| VCSEL_Delay | =338 * .03086 milliseconds = |
| | 10.43 milliseconds |

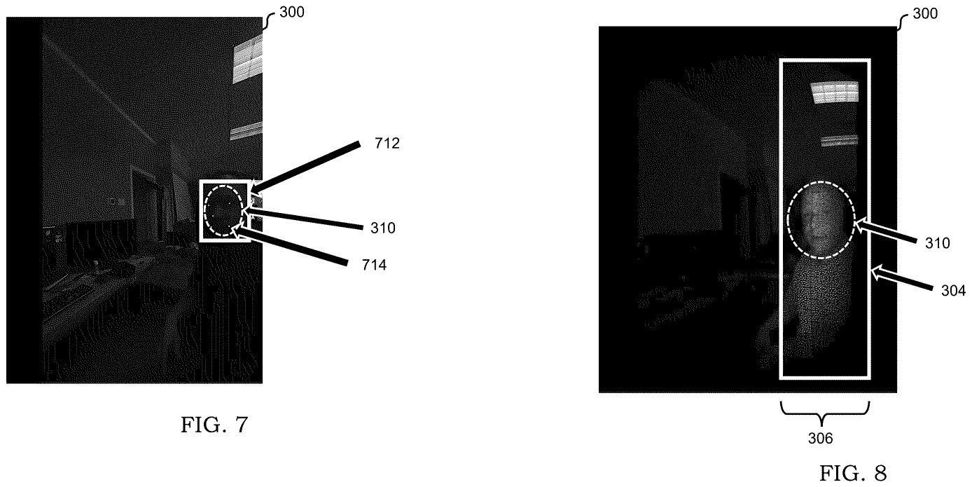

FIGS. 7 and 8 are side-by-side images of the same field of view 300 with a person positioned to one side (i.e., off-center).

FIG. 7 depicts an image of a person in field of view 300, wherein device processor 220 executing a set of instructions may analyze a color channel to determine, based on bounding box 712 and/or face identification points 714, that face 310 is present. Device processor 220 may identify, using a color channel, a presence of face 310. However, device processor 220 may be unable at this point to determine the liveness associated with face 310.

FIG. 8 depicts a screenshot of a person in field of view 300. Device processor 220 executing a set of instructions may signal a light source such as VCSEL emitter 224 to emit light at a timing frequency. Device processor 220 may further signal video camera 202 to capture video images based on a shutter speed, wherein the timing of light emissions by emitter 224 and/or the shutter speed of video camera 202 may be adjusted such that a person's face (indicated by dashed line 310) is within viewable area 304 and remains in viewable area 304 until liveness of the person is determined and either the person is authenticated and passes through an access point 100 or the person leaves the area.

Device processor 220 may further communicate with one or more access devices 102 and/or servers 32 to update information. For example, device processor 220 may communicate with one or more access devices 102 at site 10 to track when the person exits the area, how the person moves through the area, etc. Device processor 220 may communicate with servers 32, wherein servers 32 may perform additional analyses (e.g., trends, aggregates).

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for capturing an image of a face, the method comprising:
detecting a person in a field of view of a video camera fixed at the access device;
emitting patterned light into the field of view according to a patterned light timing;
capturing, by a camera, a portion of an image of the field of view, wherein the portion of the image corresponds to a window associated with a rolling shutter, wherein the window is smaller than the field of view and a position of the window relative to the field of view corresponds to a rolling shutter timing;
determining the portion of the image does not contain a face;
adjusting one or more of the rolling shutter timing and the patterned light timing such that the patterned light is emitted when the position of the window corresponds to the position of the face in the field of view; and
capturing an image of the field of view when the patterned light is emitted and the face is in the window.

2. The method of claim 1, wherein adjusting one or more of the rolling shutter timing and the patterned light timing such that the patterned light is emitted when the position of the window corresponds to the position of the face in the field of view comprises increasing or decreasing the patterned light timing.

3. The method of claim 1, wherein emitting the patterned light comprises a vertical-cavity surface-emitting-laser (VCSEL) emitting the patterned light.

4. The method of claim 1, wherein the video camera comprises a complementary metal oxide semiconductor (CMOS) video camera.

5. The method of claim 1, wherein adjusting one or more of the rolling shutter timing and the patterned light timing such that the patterned light is emitted when the position of the window corresponds to the position of the face in the field of view comprises increasing or decreasing a shutter speed of the rolling shutter.

6. The method of claim 1, wherein detecting a person in a field of view of a video camera comprises analyzing a color channel.

7. A system for capturing an image of a person in a low-light environment, the system comprising:
a patterned light emitter;
a processor executing a set of instructions to:
determine a person is in a field of view of a video camera with a rolling shutter;
determine the person is outside a visible area of the field of view;
adjust one or more of a timing of the patterned light emitter or a shutter speed of the video camera to change the visible area; and
capture an image of the person in the changed visible area.

8. The system of claim 7, wherein the patterned light emitter comprises a vertical-cavity surface-emitting-laser (VCSEL).

9. The system of claim 8, wherein the light emitter is configured to increase or decrease a timing of the VCSEL.

10. The system of claim 7, wherein the video camera comprises an infra-red (IR) video camera.

11. The system of claim 10, wherein the video camera comprises a complementary metal oxide semiconductor (CMOS) video camera.

12. The system of claim 7, wherein detecting an object in a field of view of a video camera comprises analyzing a color channel.

13. An access device fixed at an access point, the access device comprising:
a patterned light emitter;
a video camera with a rolling shutter; and
a processor executing a set of instructions to:
detect a person is in a field of view of the video camera;
determine the person is outside a visible area of the field of view; and
adjust one or more of a timing of the patterned light emitter or a shutter speed of the video camera to change the visible area; and
capture an image of the person in the changed visible area.

14. The access device of claim 13, wherein the patterned light emitter comprises a vertical-cavity surface-emitting-laser (VCSEL).

15. The access device of claim 14, wherein the patterned light emitter is configured to increase or decrease a timing of the VCSEL.

16. The access device of claim 13, wherein the video camera comprises an infra-red (IR) video camera.

17. The access device of claim 16, wherein the video camera comprises a complementary metal oxide semiconductor (CMOS) video camera.

18. The access device of claim 13, wherein detecting an object in a field of view of a video camera comprises analyzing a color channel.
